(19) United States
(12) Patent Application Publication
(10) Pub. No.: US 2022/0100594 A1
(43) Pub. Date: Mar. 31, 2022

(54) INFRASTRUCTURE MONITORING SYSTEM

(71) Applicant: ARRIS Enterprises LLC, Suwanee, GA (US)

(72) Inventor: Adhip PAL, Bangalore (IN)

(21) Appl. No.: 17/406,888

(22) Filed: Aug. 19, 2021

Related U.S. Application Data
(60) Provisional application No. 63/085,345, filed on Sep. 30, 2020.

(51) Int. Cl. G06F 11/07; H04L 12/24

(52) U.S. Cl. CPC G06F 11/079; G06F 11/0709; G06F 11/0751; H04L 41/0654; G06F 11/0793; H04L 41/069; H04L 41/16; G06F 11/0778

(57) ABSTRACT

A system for managing network devices of a communications network that includes a management system receiving log information and fault information. Based upon the log and fault information, the management system attempts to mitigate the fault using a machine learning process.

### CROSS-REFERENCE TO RELATED APPLICATIONS

This application claims the benefit of U.S. Provisional Patent Application Ser. No. 63/085,345 filed Sep. 30, 2020.

### BACKGROUND OF THE INVENTION

A network management system can be associated with communication networks, with the purpose of collecting alarms from network equipment and/or software applications, forming a summary of the collected alarms, particularly using correlation methods, and displaying this alarm summary to an operator so that the operator can implement corrective action in the case of a failure of the network equipment and/or software applications. The concept of a “failure” or “fault” is understood to be a very general term for any type of hardware and/or software malfunction. Network equipment and/or software application that is no longer operational in some manner is considered to have a failure. Likewise, an improper configuration of network equipment and/or software application is considered to have a failure.

Network management systems can be used to configure network equipment and/or software applications. The operator can input new parameters using a man-machine interface and the network management system applies these new parameters to the network equipment and/or software applications. In this way, the operator can correct a network failure in reaction to an alarm.

Such a centralized analysis depends on collection of a large amount of data and alarms from many elements in the communication system. These elements may be network equipment, such as for example, routers, switches, computer servers, networking cards and other components of computer servers, inclusive of software applications.

Due to the many interactions between network elements, a single failure can generate a substantial number of alarms. Thus, a failure on a router may generate an alarm from other network equipment and/or software applications connected to one of the ports on the router. It is therefore difficult for the operator to determine which is the genuine failure among the large number of generated alarms, and even more so to determine the corrective action to be undertaken.

Nevertheless, the operator has to take action with each failure to determine the corrective action(s) to be undertaken and to undertake the corrective action(s). The operator then needs to reconfigure the network equipment and/or software applications, using the network management system or to manually connect to one or more of the network equipment and/or software applications, and send the appropriate CLI (command line interface) commands.

The foregoing and other objectives, features, and advantages of the invention may be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a communication network.

FIG. 2 illustrates a list of network devices.

FIG. 3 illustrates a list of network devices.

FIG. 4 illustrates a management system.

FIG. 5 illustrates a fault mitigation process.

FIG. 6 illustrates a predictive fault mitigation process.

FIG. 7 illustrates an exemplary system for fault mitigation.

### DETAILED DESCRIPTION OF PREFERRED EMBODIMENT

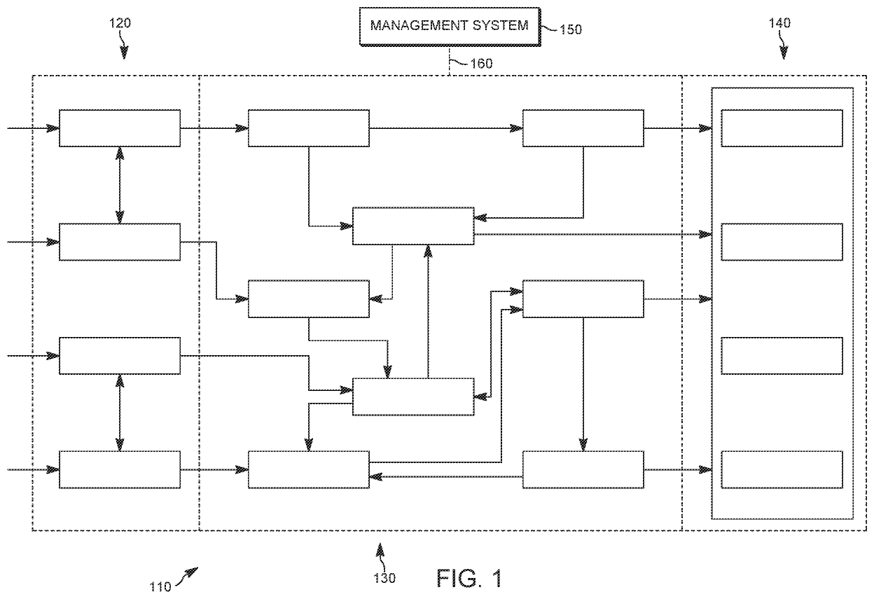

Referring to FIG. 1, a video delivery system 110 may include many software applications that receive video content and associated metadata for the video content 120, a multitude of software applications that process the received video content and the associated metadata for the video content 130, and a substantial number of software applications that are suitable for different client applications 140. For example, the client applications may include different types of mobile phones, different types of tablets, different types of laptop computers, different types of desktop computers and/or servers, and/or different operating systems and versions thereof. As it may be observed, there are a multitude of different software applications running on a multitude of different computing devices and networking equipment, inclusive of a multitude of servers. The software applications are interconnected with one another, in a complicated processing environment, to achieve a high performance video processing system. A multitude of software applications and/or network equipment may be used to provide computing functionality for a multitude of other applications.

In many cases, the software applications are isolated from one another using software containers, such that for example, the software application may not see and are not aware of other software applications operating on the same machine. A plurality of software containers may be instantiated and operated on one or more servers and/or one or more virtual machines operating on the one or more servers. In addition, the containers may be managed, at least in part, using a container orchestration system. Each of the containers are isolated from one another and bundle their own software, libraries, and configuration files. The containers may communicate with one another using defined channels. This containerization increases the flexibility and portability on where the software applications may run. Each of the software applications 120, 130, 140 may be interconnected with a management system 150, such as using a network connection 160.

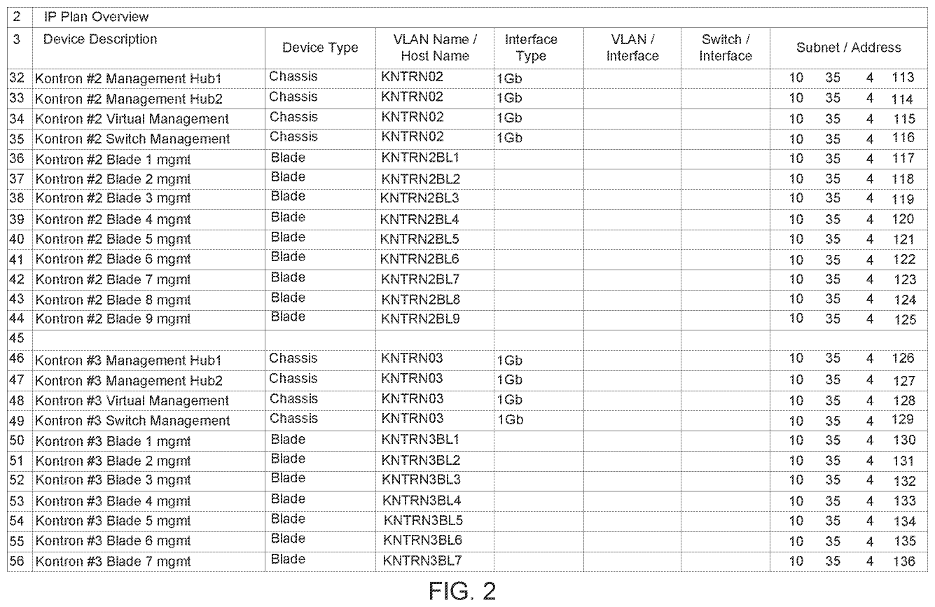

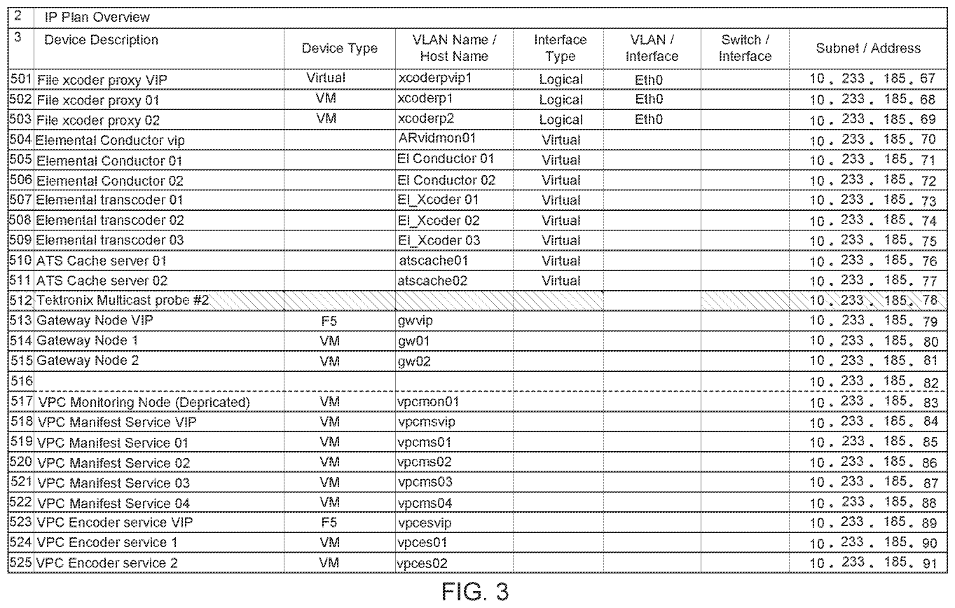

Referring to FIG. 2 and FIG. 3, the management system 150 may include a spreadsheet of the software applications and/or network devices, such as organized by application description, device type, VLAN name, and a corresponding network address identification. An operator may examine each of the log files for each of the software applications to determine the operational characteristics of each network devices and/or software applications. For a relatively complicated set of software applications there may hundreds of software applications, operating on a substantial number of network devices (e.g., computer servers). In the event of a fault, it can be problematic to identify the software applications with the error within the multitude of potential interrelated software applications. To simplify the identification of network devices and/or software applications that have an identified fault, an additional software program may be used to graphically illustrate which network devices and/or software applications have a fault, such as a red indication of a fault or a green indication of no fault. While the identification of a fault may be identified from the list of devices, or the graphical illustration, it is problematic to determine an appropriate action to mitigate the issue.

For example, a software application may experience a failure. The management system 150 may receive a fault notification based upon network device and/or software application monitoring applications (e.g., generally referred to as an agent). Based upon the fault notification a support engineer may attempt to diagnose the source of the fault notification. Initially, the support engineer may determine a list of potential candidates of network devices and/or software applications that may have encountered a failure, and determine the available log files related to the potential list of candidates, and download the available log files from a multitude of network devices and/or software applications. Then the support engineer may determine it is desirable to initiate a rebooting of one or more software applications to attempt to remedy the fault condition. If the software applications, as a result of rebooting the software applications, operates properly then the corrective action may be considered successful.

By way of example, a manifest delivery controller is a software application running on a computer server for modifying video manifests to enable server-side dynamic advertisement insertion, content personalization, and analytics for Internet protocol based video. The management system 150 may receive a fault notification that the manifest delivery controller has failed. Based upon the additional information obtained from one or more log files, a support engineer may attempt to diagnose the source of the fault notification. Initially, the support engineer may determine it is desirable to initiate a rebooting of the manifest delivery controller to attempt to remedy the fault condition. If the manifest delivery controller, as a result of rebooting the manifest delivery controller, fails to operate properly then the support engineer needs to further examine the logs to attempt to determine an appropriate course of action. Unfortunately, it can be rather time consuming to determine an appropriate course of action.

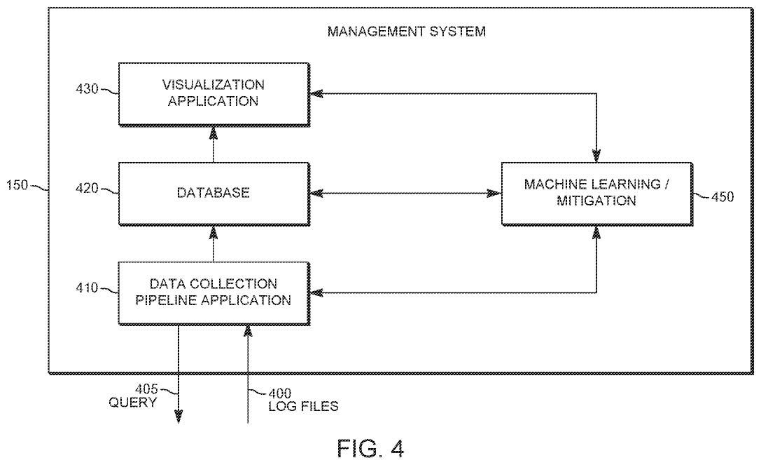

Referring to FIG. 4, the management system 150 provides a centralized location for management of the network devices and/or software applications based upon receiving log files 400. The management system 150 may use a search, a database, and a visualization stack of software. The search, database, and visualization stack of software facilitates the searching, the analyzing, and the visualization of log files in real time. The log files 400 from each of the containers and/or the network devices and/or the software applications and/or computers/servers (generally referred to collectively as network devices) may be collected with a data collection pipeline application 410. The data collection pipeline application 410 collects data inputs and feeds them into a database 420. The data collection pipeline application 410 facilitates the acquisition of different types of log files, filtering as desired, parsing as desired, and feeds them into the database 420, which may be in response to a query 405 if desired. In this manner, system logs may be obtained related to the computer servers and/or the network devices, inclusive of memory usage and processor usage. In this manner, network logs may be obtained related to networking devices and networking usage characteristics, such as routers and switches and bandwidth usage. In this manner, application logs may be obtained related to software applications.

The database 420 stores the log files, and facilitates the storing, searching, and analyzing of substantial volumes of data. A visualization application 430 facilitates presentation of the documents and provides insight into the nature of the documents. The visualization application 430 may provide graphs to visualize complex queries. The management system 150 also preferably proactively acquires log files and updates previously acquired log files, from the various network devices and/or software applications or otherwise associated with the system 110 on a regular basis. This log file acquisition is performed on a regular basis, prior to any particular fault being detected, signaled, or otherwise occurring. The resulting log files are stored in the database 420 and are available to the management system 150 for subsequent processing. As it may be observed, using a centralized logging system facilitates more efficient management and processing of log files, which may otherwise be located on hundreds or thousands of worker nodes. The database of existing log files may be analyzed for debugging issues with deployed software application, such as determining a reason for a container termination, a software application termination, network device failure, or otherwise.

The management system 150 may include a machine learning/mitigation process 450 that builds a model based upon sample data, generally referred to as training data, in order to make decisions without having to be explicitly programmed to do so. Any machine learning technique may be used, including for example, supervised learning, unsupervised learning, reinforcement learning, topic modeling, dimensionality reduction, deep learning, and meta learning. The training data may include the log files 400 from each of the respective network devices and/or software applications together with a course of action that was used to repair the fault and/or course of actions that did not result in repair of the fault, each of which may include one or more actions. With a sufficiently large set of training data that includes the course of actions that were successful and/or unsuccessful, the machine learning process 450 may have a trained state.

The management system 150 may include a log file acquisition process that retrieves the log files from the corresponding network devices and/or software applications upon a fault being detected, or otherwise periodically receives and updates the log files from the network devices on a continual basis so that the log files are already present in the database 420. In this manner, preferably when a fault is triggered for one or more network devices and/or software applications by a corresponding one or more monitoring applications, the log files have already been received by the log file acquisition process prior to the fault occurring or otherwise received by the log file acquisition process in response to receiving one or more faults. A mitigation process within the machine learning process 450 receives the fault indication and, based upon the corresponding log files from the database 420, processes the log files using the trained machine learning process 450. In response, the mitigation process suggests an appropriate manner of mitigating the fault. Based upon any suitable criteria, the mitigation process may automatically perform the determined one or more mitigation activities. If as a result of the automatic mitigation activities, such as restarting the device and/or software process, or reinstalling and/or reconfiguring the device and/or software process, the fault remains then the fault may be elevated to an appropriate support engineer with supporting documentation regarding the fault, including appropriate suggestions from the machine learning process 450 based upon previous encounters with the same or similar faults.

The support engineer may go through the log files that have been retrieved and identified by the machine learning process 450, together with examination of additional data previously remaining on the network devices, if desired, to make an analysis of what is the likely root cause for the fault.

By way of example, the management system 150 may receive e-mail alerts of faults, such as each time a network device loses network connectivity. If desired, the e-mail alerts that identify faults may be processed by the mitigation process to attempt a mitigation of the fault.

By way of example, the management system 150 may identify faults, such as each time a network device loses network connectivity, based upon a search of the network devices using an interface. If desired, the faults may be processed by the mitigation process to attempt a mitigation of the fault.

By way of example, the management system 150 may identify faults based upon a search criteria, such as each time a network device loses network connectivity based upon the search criteria, based upon a search of the network devices using an interface. If desired, the faults may be processed by the mitigation process to attempt a mitigation of the fault.

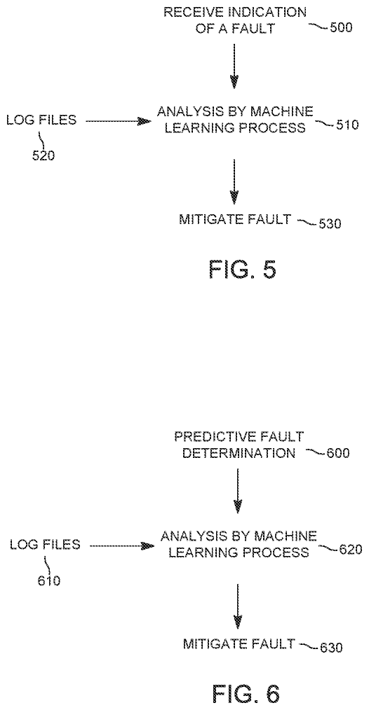

Referring to FIG. 5, the management system 150 may receive an indication of a fault 500 and based upon an analysis by the machine learning process 510 based upon log files 520, such as those already present in the database 420, the management system may with operator assistance or automatically attempt to mitigate the fault 530. While functional, this provides a reactive approach to the mitigation of faults as they occur.

Referring to FIG. 6, the management system 150 may provide increasingly higher robustness by including a predictive fault determination 600 based upon an analysis of the log files 610 included in the database 420 using the machine learning process 620. The management system may with operator assistance or automatically attempt to mitigate the predicted fault 630. The predictive fault determination 600 may predict the future state of a hardware device. The predictive fault determination 600 may predict the future state of a software application. The predictive fault determination 600 may predict the future state of a computing device/server. In this manner, the predictive state of the system may be determined based upon the metrics which are being received from the log files. By way of example, the state of the log files over time, and the subsequent fault determination, together with successful and/or unsuccessful mitigation may be used as the basis for creating and updating the predictive model included in the machine learning process 450.

In addition, the predicted fault determination 600 may be presented, together with informational details, in the visualization application 430. In this manner, the operators of the system may visualize the predictive nature of the system, so that proactive actions may be taken to maintain a stable system or otherwise avoid catastrophic future failures.

By way of example, a computing device may be using substantially more memory and/or substantially more processor usage than is typical under the operating conditions. This information may be included in the log files being received by the management system 150. The predictive fault determination 600 may predict that a fault is likely to occur based upon determining using substantially more memory and/or substantially more processor usage is occurring than is typical under the operating conditions. Based upon the prediction, the management system 150 may attempt to mitigate the process, such as for example, triggering mitigation activities (e.g., killing one or more processes, restarting one or more processes, restarting one or more hardware devices). In addition, or alternatively thereto, the management system 150 may automatically create a ticket that is provided to technical support, such as a support engineer. The automated creation of a ticket, which indicates the nature of predicted fault, facilitates a reduction in labor to maintain the system because potential faults may be mitigated before they become substantial.

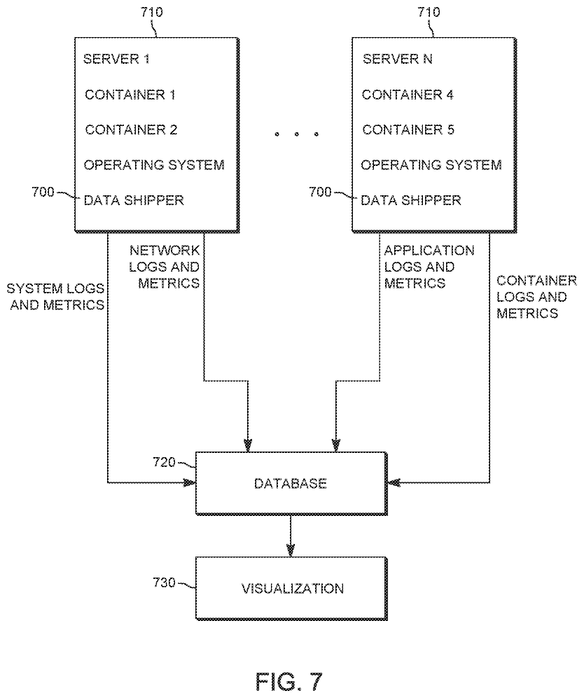

Referring to FIG. 7, an exemplary implementation is illustrated. The software agents may be in the form of data shippers 700, that are installed as agents on the devices and/or software 710 to provide operational data to the database 720. By way of example the data shippers 700 may be associated with containers, network devices, and/or software applications. By way of example, the data shippers 700 may provide audit data, cloud data, availability, system journal metrics, network traffic operating system events, all of which are generally referred to as log files. A visualization application 730 may make determinations based upon the log files in the database, together with a machine learning and mitigation system 740.

As it may be observed, the management system that includes machine learning to achieve fault mitigation without any manual intervention. As it may be observed, the management system that includes machine learning achieves fault mitigation with manual intervention, with the supplementation of suggested mitigation suggestions.

The identification of faults and the mitigation of the faults, either by an automatic process or a process based in part on the activities of a support engineer, may be provided back to the machine learning process to provide additional training. The additional training of the machine learning process may then be used for the subsequent faults and predictions, to provide a more robust system.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for managing network devices interconnected to a communications network comprising:
(a) receiving, by a management system, first log information from a first agent associated with a first said network device interconnected to said communications network;
(b) receiving, by said management system, second log information from a second agent associated with a second said network device interconnected to said communications network;
(c) receiving, by said management system, a first fault from said first agent indicating said first network device has a failure received after receiving said first log information;
(d) after receiving said first fault said management system using a machine learning process identifying a first source of said first fault based upon said first log information and visualizing a first source of said fault to an operator;
(e) after identifying said first source of said first fault said management system performing a mitigation process to attempt to remedy a cause of said first fault.

2. The method of claim 1 wherein said first network device is a hardware device.

3. The method of claim 1 wherein said first network device is software.

4. The method of claim 1 wherein said machine learning process is trained based upon log information from network devices together with fault information.

5. The method of claim 4 wherein said machine learning process is trained based upon courses of action that resulted in repairs of faults.

6. The method of claim 1 wherein said machine learning process is modified based upon said first log information and said first fault.

7. The method of claim 6 wherein said machine learning process is modified based upon a mitigation of said first fault.

8. The method of claim 7 wherein said mitigation of said first fault includes one or more actions that mitigated said first fault.

9. The method of claim 8 wherein said mitigation of said first fault includes one or more actions that failed to mitigate said first fault.

10. A method for managing network devices interconnected to a communications network comprising:
(a) receiving, by a management system, first log information from a first agent associated with a first said network device interconnected to said communications network;
(b) receiving, by said management system, second log information from a second agent associated with a second said network device interconnected to said communications network;
(c) prior to receiving, by said management system, a first fault from said first agent of said management system indicating said first network device has a predicted failure using a machine learning process based upon said first log information.

11. The method of claim 10 further comprising said management system performing a mitigation process to attempt to remedy a cause of said first fault which has not been received.

12. The method of claim 10 wherein said first network device is a hardware device.

13. The method of claim 10 wherein said first network device is software.

14. The method of claim 10 wherein said prediction is visualized to an operator.

15. The method of claim 10 wherein said first fault is not subsequently received.
